(19) United States
(12) Patent Application Publication
(10) Pub. No.: US 2026/0277375 A1
(43) Pub. Date: Sep. 17, 2026

(54) METHOD, APPARATUS, DEVICE, AND STORAGE MEDIUM OF INTERFACE INTERACTION

(71) Applicant: Bytedance Technology Ltd., Grand Cayman (KY)

(72) Inventors: Xin LI, Beijing (CN); Xiu PEI, Beijing (CN)

(21) Appl. No.: 19/566,856

(22) Filed: Mar. 13, 2026

(30) Foreign Application Priority Data
Mar. 13, 2025 (WO) PCT/SG2025/050177

(51) Int. Cl. G06F 3/0481; G06F 3/0484; G06F 3/16; G11B 27/031

(52) U.S. Cl. CPC G06F 3/0481; G06F 3/0484; G06F 3/165; G11B 27/031

(57) ABSTRACT

A method, an apparauts, a device, and a storage medium of interface interaction are provided. The method provided herein includes: presenting a detail interface of first music content; presenting, in response to a current user not having a predetermined permission with regard to the first music content, a first editing entry in the detail interface; and presenting, in response to a trigger for the first editing entry, a first editing interface associated with second music content. The second music content is determined based on the first music content. The current user has the predetermined permission with regard to the second music content.

### CROSS REFERENCE

This application claims priority to PCT Application No. PCT/SG2025/050177, filed on Mar. 13, 2025 and entitled “METHOD, APPARATUS, DEVICE, AND STORAGE MEDIUM OF INTERFACE INTERACTION”, the entirety of which is incorporated herein by reference.

### FIELD

Example embodiments of the disclosure generally relate to the field of computers, and in particular, to a method, an apparatus, a device, and a computer-readable storage medium of interface interaction.

### BACKGROUND

With the continuous development of Internet technologies, users may browse various media contents through the Internet. In the related art, music content associated with media content may be viewed for details, for example, whether the user has a permission to use the music content, etc.

### SUMMARY

In a first aspect of the disclosure, a method of interface interaction is provided. The method includes: presenting a detail interface of first music content; presenting, in response to a current user lacking a predetermined permission with regard to the first music content, a first editing entry in the detail interface; and presenting, in response to a trigger for the first editing entry, a first editing interface associated with second music content, wherein the second music content is determined based on the first music content, and the current user has the predetermined permission with regard to the second music content.

In a second aspect of the disclosure, an apparatus of interface interaction is provided. The apparatus includes a first interface presentation module, a first entry presentation module and a second interface presentation module, wherein the first interface presentation module is configured to present a detail interface of first music content; the first entry presentation module is configured to present, in response to a current user lacking a predetermined permission with regard to the first music content, a first editing entry in the detail interface; and the second interface presentation module is configured to present, in response to a trigger for the first editing entry, a first editing interface associated with second music content, the second music content is determined based on the first music content, and the current user has the predetermined permission with regard to the second music content.

In a third aspect of the disclosure, an electronic device is provided. The device includes at least one processor; and at least one memory coupled to the at least one processor and storing instructions for execution by the at least one processor. The instructions, when executed by the at least one processor, cause the device to perform the method of the first aspect.

In a fourth aspect of the disclosure, a computer-readable storage medium is provided. The computer-readable storage medium stores a computer program thereon, and the computer program is executable by a processor to implement the method of the first aspect.

It should be understood that the content described in this content section is not intended to limit the key features or major features of the embodiments of the disclosure, nor is it intended to limit the scope of the disclosure. Other features of the disclosure will become readily understood from the following description.

### BRIEF DESCRIPTION OF DRAWINGS

The above and other features, advantages, and aspects of various embodiments of the disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments according to the disclosure may be implemented;

FIGS. 2A-2D illustrate example interfaces according to some embodiments of the disclosure;

FIG. 3 illustrates a flowchart of an example process of a method of interface interaction according to some embodiments of the disclosure;

FIG. 4 illustrates a schematic structural block diagram of an example apparatus for interface interaction according to some embodiments of the disclosure; and

FIG. 5 illustrates a block diagram of an electronic device capable of implementing various embodiments of the disclosure.

### DETAILED DESCRIPTION

Embodiments of the disclosure will be described in more detail below with reference to the accompanying drawings. While certain embodiments of the disclosure are shown in the accompanying drawings, it should be understood that the disclosure may be implemented in various forms, and should not be construed as limited to the embodiments set forth herein, but rather, these embodiments are provided for a more thorough and complete understanding of the disclosure. It should be understood that the drawings and embodiments of the disclosure are for illustrative purposes only and are not intended to limit the scope of the disclosure.

It should be noted that a title of any section / subsection provided herein is not limiting. Various embodiments are described throughout and any type of embodiments may be included in any section / subsection. Furthermore, the embodiments described in any section / subsection may be combined in any manner with any other embodiment described in the same section / subsection and / or different sections / subsections.

In the description of the embodiments of the disclosure, the terms “including” and the like should be understood as open-ended inclusion, i.e., “including but not limited to”. The term “based on” should be understood as “based at least in part on”. The terms “an embodiment” or “the embodiment” should be understood as “at least one embodiment”. The term “some embodiments” should be understood as “at least some embodiments”. Other explicit and implicit definitions may also be included below. The terms “first”, “second” and the like may refer to different or identical objects. Other explicit and implicit definitions may also be included below.

Embodiments of the disclosure may relate to data of a user, acquisition and / or use of data, and the like. These aspects all follow the corresponding laws and regulations and related regulations. In the embodiments of the disclosure, all data is collected, obtained, processed, treated, forwarded, used, etc., on the premise of knowledge and confirmation of the user. Accordingly, when implementing the embodiments of the disclosure, the type, the usage scope, the usage scenario, and the like of the data or information that may be involved, should be notified to the user and the authorization thereof should be obtained from the user in an appropriate manner according to the relevant laws and regulations. The specific notification and / or authorization manner may vary according to actual situations and application scenarios, and the scope of the disclosure is not limited in this regard.

According to the solutions in the present specification and the embodiments, for example, personal information processing is involved, processing may be performed on the premise of having a legality basis (for example, obtaining consent of a personal information subject, or necessary for performing a fulfillment contract), and processing may be performed only within a specified or agreed range. The usage of a basic function will not be affected if the user rejects personal information other than necessary information required by the basic function.

As mentioned above, with the continuous development of Internet technology, users may browse various types of media content through the Internet, such as segment selection content of film and television works, video content associated with background music, and the like.

Taking media content associated with music content as an example, the music content associated with the media content may be viewed for details, for example, description information such as a music name and an author of the music content. For another example, information such as other media content that uses the music content may also be viewed.

However, in the related art, viewing the details of the music content may be viewed on the premise that the music is authorized to be used, for example, the music content is authorized to be used on the platform or the music content is authorized to be viewed or used by the user. For unauthorized music content, the detail interface cannot be viewed, or other content cannot be further viewed or other operations cannot be performed on the detail interface based on the music content.

Embodiments of the disclosure provide a solution of interface interaction. The solution includes the following steps: presenting a detail interface of first music content; presenting, in response to a current user not having a predetermined permission with regard to the first music content, a first editing entry in the detail interface; and presenting, in response to a trigger for the first editing entry, a first editing interface associated with the second music content. The second music content is determined based on the first music content, and the current user has the predetermined permission with regard to the second music content.

In this way, the embodiments of the disclosure enables viewing the detail interface of the music content without permission (also called “unpermitted music content”), and provides, inside the detail interface, the media editing entry based on the music content with permission (also called “permitted music content”), that is associated with the music content without permission, thereby enriching the detail interface of the music content without permission, and improving the user experience.

Various example implementations of this solution are described in detail below in conjunction with the accompanying drawings.

### Example Environment

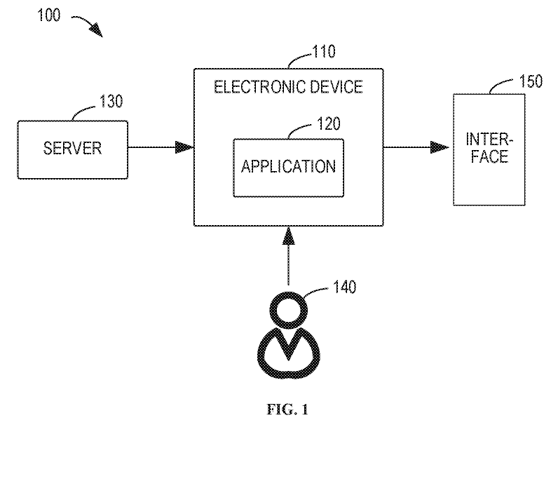

FIG. 1 illustrates a schematic diagram of an example environment 100 in which embodiments of the disclosure may be implemented. As shown in FIG. 1, the example environment 100 may include an electronic device 110.

In this example environment 100, the electronic device 110 may run an application 120 that supports interface interaction. The application 120 may be any suitable type of application for interface interaction, examples of which may include, but are not limited to: multimedia interaction, audio playback, video playback, or other suitable application. The user 140 may interact with the application 120 via the electronic device 110 and / or its attachment device.

In the environment 100 of FIG. 1, if the application 120 is in an active state, the electronic device 110 may present, via the application 120, an interface 150 for supporting interface interaction.

In some embodiments, the electronic device 110 communicates with a server 130 to implement the supply of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR / AR device, a personal communication system (PCS) device, a personal navigation device, a personal digital assistant (PDA), an audio / video player, a digital camera / camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a “wearable” circuit, etc.).

The server 130 may be a standalone physical server, a distributed system or a server cluster composed of multiple physical servers, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system / server, such as a mainframe, an edge computing node, a computing device in a cloud environment, or the like. The server 130 may provide a background service for the application 120 supporting interface interaction in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the disclosure are not limited in this regard. In an embodiment of the disclosure, the server 130 and the electronic device 110 may implement signaling interaction through a communication connection between the server 130 and the electronic device 110.

It should be understood that the structures and functions of various elements in the environment 100 are described for illustrative purposes only and do not imply any limitation to the scope of the disclosure.

Some example embodiments of the disclosure will be described below with continued reference to the accompanying drawings.

### Example Interaction

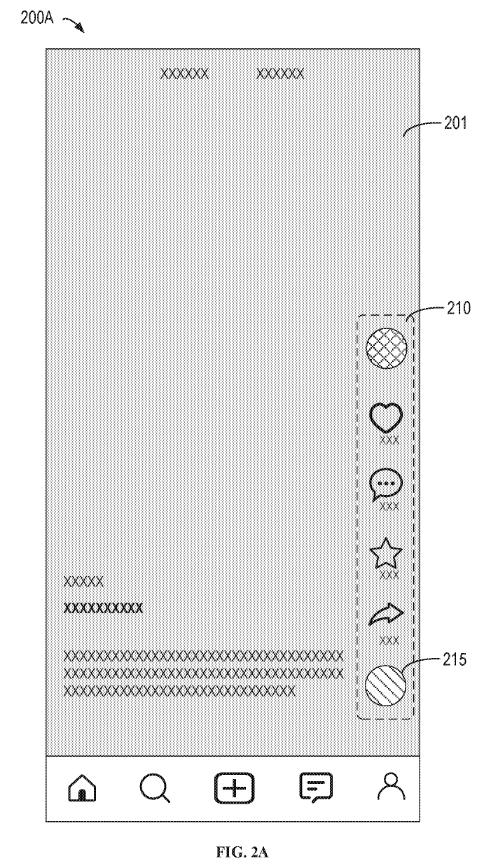

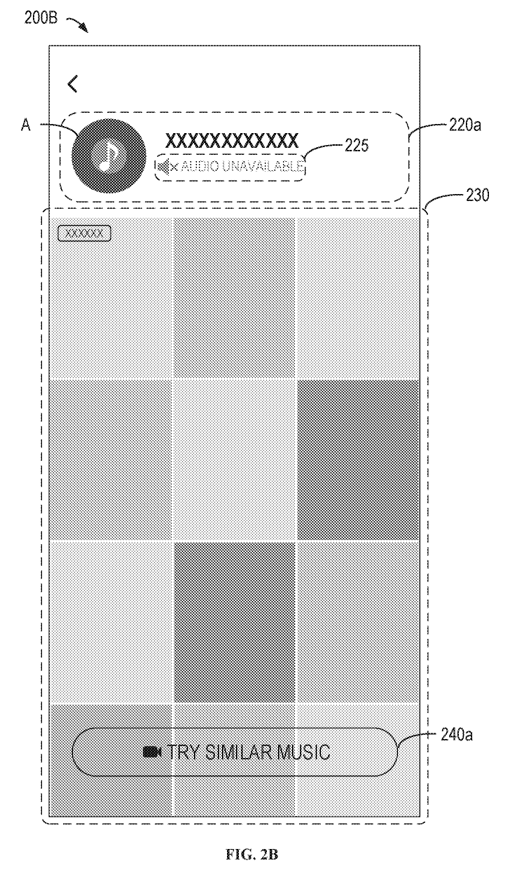

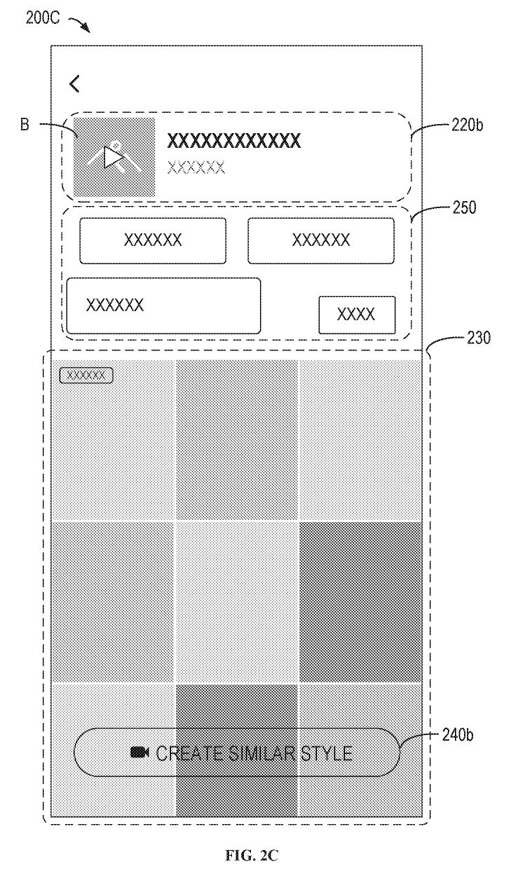

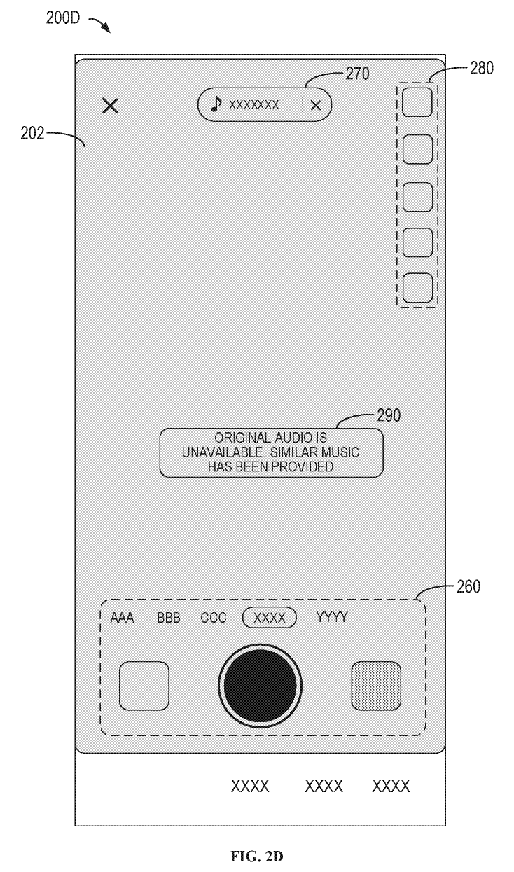

FIGS. 2A-2D illustrate example interfaces 200A-200D according to some embodiments of the disclosure. The interfaces 200A-200D may be provided, for example, by the electronic device 110 shown in FIG. 1.

Referring to FIG. 2A, FIG. 2A illustrates an example playback interface 200A according to some embodiments of the disclosure. Illustratively, the electronic device 110 may present the playback interface 200A based on a response to an operation that the application 120 has been installed, or based on a response to at least one operation in the application 120.

As an example, the playback interface 200A may correspond to media content 201 for frame-by-frame presentation of the media content 201. For example, video frames associated with a preset speed may be presented frame by frame at a preset speed (e.g., ×1, ×0.5, ×2, etc.).

In some embodiments, the playback interface 200A may be an initial playback interface presented by the application 120 shown in FIG. 1, or may be a playback interface presented after any media content in the application 120 is further operated, which is not limited herein.

In some implementations, description information of the media content 201, such as title information, tag information, summary information, etc., of the media content 201 may be presented at the bottom of the playback interface 200A.

As shown in FIG. 2A, the playback interface 200A includes an operation panel 210, and the operation panel 210 includes at least one operation control, for example, an operation control configured to follow / unfollow an author of the media content 201, for another example, an operation control such as a like control, a comment control, a favorite control, and a sharing control for the content presented in the media content 201, and for another example, an operation control configured to view or refer music content, a special effect template, a description template and the like associated or applied in the media content 201.

In some embodiments, via any operation control in the operating panel 210, a corresponding operation of the user may be received and responded to. As an example, a viewing operation for music content associated with the media content 201 may be received via an operation control 215 as shown in FIG. 2A. In response to the viewing operation, the electronic device 110 may present a detail interface of the music content, for example, a detail interface 200B shown in FIG. 2B, and for another example, a detail interface 200C shown in FIG. 2C.

It should be noted that, in this solution, the music content associated with the media content in the playback interface 200A may be music content with permission or music content without permission. The permission mentioned in this solution may include at least one of a listening permission of the music content, an editing permission, an associated creation permission based on the music content, a copyright of the music content, and the like.

In some embodiments, for the detail interface of the music content without permission and the detail interface of the music content with permission, the presented contents may be different.

FIGS. 2B and 2C illustrate example detail interface 200B and interface 200C, respectively, according to some embodiments of the disclosure. As shown, the detail interface 200B shown in FIG. 2B is a detail interface of unpermitted music content A, that is, in the scenario shown in FIG. 2B, the current user does not have a predetermined permission of the unpermitted music content A; the detail interface 200C shown in FIG. 2C is a detail interface of the permitted music content B, that is, in the scenario shown in FIG. 2C, the current user has a predetermined permission of the permitted music content B.

The detail interface of the music content is illustratively described below with reference to FIGS. 2B and 2C.

Referring to FIG. 2B, the detail interface 200B includes a detail panel 220a of the unpermitted music content A; referring to FIG. 2C, a detail panel 200b of the permitted music content B is included in the detail interface 200C.

As an example, the detail panel 220a and the detail panel 220b may both present at least one information such as a music cover, a music name, author information, interaction information, or playback information of the corresponding music content.

In some embodiments, the music cover may be any associated image such as an author image of the music content, an album cover to which the music content belongs, or may be any preset image in a preset image set, for example, a preset image in a style of a vinyl record or a preset image that only presents a music symbol, which is not limited herein.

As shown in FIG. 2B, for the detail interface 200B of the unpermitted music content A, the music cover may use a unified image in the style of a vinyl record or a music symbol style. In some implementations, an author image or other associated image of the music content may also be selected without exceeding the permission. Comparatively referring to FIG. 2C, for the detail interface 200C of the permitted music content B, the music cover may select an author image of the permitted music content or a cover image of the music album to which the permitted music content belongs, or may select other image related to the permitted music content, so as to present the music content from the perspective of images through the music cover.

In some embodiments, for the music cover of the permitted music content B, it may not only be presented as one piece of associated information of the permitted music content B, but also may serve as a trigger control for the permitted music content B, for example, the permitted music content B may be played or paused by clicking the music cover.

In some embodiments, for the music cover of the unpermitted music content A, it may only be presented as one of the associated information of the music content, but may not be configured as a trigger control, that is, the unpermitted music content A is not played; or it may be configured as a trigger control, but based on the trigger control being triggered, a preset partial segment of the unpermitted music content A may only be played, for example, a start music segment with a preset duration.

In some embodiments, for the permitted music content, a complete music name is displayed in the detail panel 220b; for the unpermitted music content A, universal name information such as “original sound” may be displayed in the detail panel 220a, or the complete music name may be displayed in a form different from the permitted music content B (for example, in a gray text, an inclined text, etc.).

In some embodiments, for unpermitted music content A, author information may not be presented. For the permitted music content B, the author information presented may include an author name.

Illustratively, in the detail interface 200C, the author information may not only be presented as one of the associated information of the music content, but also may be presented as a trigger entry, for example, via a trigger for the author information, a music list interface published by the author may be entered to view other music content published by the same author.

As an example, the music name, author information, interaction information, and the like for the permitted music content B may be displayed normally or highlighted in a preset mode. The music name, author information, interaction information, and the like of the unpermitted music content A may be displayed in a form distinguishing from the permitted music content, for example, by reducing a display brightness or a color gamut, reducing a text font size, changing a text font, or the like, and even hiding the author information, interaction information and the like to not be displayed, so as to enhance the difference from the presentation style of the permitted music content B.

In some embodiments, the interaction information may be at least one of the number of favorites for the music content, the number of times that it has been associated and referred, and the like, which is not limited herein. As an example, for the permitted music content B, historical interaction information of the permitted music content may be presented; for the unpermitted music content A, corresponding interaction information may be hidden.

Referring to FIG. 2B, in some embodiments, the detail panel 220a includes playback information 225.

As an example, for the unpermitted music content A, the playback information 225 may present prompt information for the unpermitted music content A, such as “audio unavailable” “audio cannot be played” and “no permission to use”.

In some optional implementations, for the permitted music content, the playback information may also be presented, and the presented playback information may indicate whether the music content is played, a current playing progress, and the like, and for music content with an associated text (for example, lyrics), the playback information may further include the associated text of the currently played content, and the like.

Referring to FIG. 2C, in some embodiments, for the permitted music content B, at least one set of control panels 250 may also be presented in the detail interface 200C, and at least one operation control for the music content is included in the control panel 250.

Illustratively, the operation control in the control panel 250 may include at least one of the following: listening to the full music, making favorites, sharing, making likes, commenting, adding to the list, searching, viewing a list, and the like.

In this way, the user is facilitated to view information associated with the permitted music content or perform a corresponding association operation.

Comparatively referring to FIG. 2B, in some embodiments, for the unpermitted music content A, the control panel may be hidden in the detail interface 200B. In some optional implementations, the control panel may also be presented in a gray and non-triggerable mode.

In some embodiments, for the unpermitted music content A, a permission obtaining control (not shown) may be further provided in the corresponding detail interface 200B to obtain at least one permission such as viewing, using, editing and the like corresponding to the unpermitted music content. In addition, after it is determined that the current user obtains the permission corresponding to the unpermitted music content through the permission obtaining control, the display mode of the current detail interface 200B is updated, and a display mode of the detail interface corresponding to the permitted music content is presented, for example, the updated detail interface may be a display mode shown in FIG. 2C.

Referring collectively to FIGS. 2B and 2C, each of the detail interface 200B and the detail interface 200C may also present a corresponding set of media content 230a and 230b associated with the music content.

In some embodiments, the set of media content 230a or 230b may include a portion or all of the media content that references or associates the corresponding music content A or B. For example, the set of media content 230a may be all media content associated with the music content in a media database or set of media content of the application 120.

In some embodiments, the set of media content 230a or 230b may also include at least a portion of the media content determined based on other associated content (e.g., a template, a special effect, etc.) of the media content 201 or based on associated content (e.g., author, album, similarity, etc.) of the music content A or B, which is not limited herein.

In some embodiments, a first set of media content 230a or 230b may be presented in the detail interface 200Bor 200Cin the form of a waterfall flow. For example, the first set of media content 230a or b may be presented in the form of a fixed or interleaved waterfall flow. As an example, both FIGS. 2B and 2C present the first set of media content 230a and 230b by using a three-column distributed fixed waterfall flow. In other implementations, the first set of media content may also be presented by using a waterfall flow distributed in two columns or four columns, which is not limited herein.

In some embodiments, the set of media content 230a or 230b, when the current page fails to be fully displayed, needs to be presented by sliding the page, e.g., by sliding the current page upwards.

Referring to FIG. 2B, the detail interface 200B further includes an editing entry 240a. Based on the editing entry 240a, a media editing interface may be presented, and new media content is generated by a work conversion performed based on another permitted music content similar to the unpermitted music content A.

In this way, similar permitted music content may be provided for the unpermitted music content, and the work conversion is performed accordingly, providing a new path of work conversion, and effectively improving the work conversion rate and the user experience.

Comparatively referring to FIG. 2C, the detail interface 200C includes an editing entry 240b. Based on the editing entry 240b, the electronic device 110 may present a media editing interface to perform a similar work conversion on the permitted music content B presented in the current detail interface 200C or other associated content (for example, a template, a special effect, or the like) in the media content to which it belongs, to generate new media content.

In this way, the work conversion of the permitted music content B described in the detail panel 220b or other related content in the media content to which it belongs can be quickly performed, improving the work conversion rate of the permitted music content or other related content in the media content to which it belongs, improving the generation efficiency of the new media content, improving the user operation convenience, and improving the user experience.

In some embodiments, as shown in FIG. 2C, the music content described by the detail panel 220b is the permitted music content B, and the editing entry 240b may represent a product conversion operation entry that enables edition or creation based on the permitted music content B. That is, based on the trigger for the editing entry 240b, a media editing interface may be entered, and the creation or edition of the media content may be performed based on the permitted music content B in the media editing interface, for example, using the permitted music content as a background music of the media content, etc.

In this solution, a solution triggered based on the editing entry 240a provided by the unpermitted music content A is mainly introduced. FIG. 2D illustrates a schematic diagram of a media editing interface 200D according to some embodiments of the disclosure.

Referring collectively to FIGS. 2B and 2D, the electronic device 110 may present the media editing interface 200D based on the trigger for the editing entry 240a in the detail interface 200B.

Referring to FIG. 2D, in the editing interface 200D, a display panel 202 is included, and an option panel 260 is provided in the display panel 202. The option panel 260 includes at least one editing option for generating media content.

In some embodiments, the editing option in the option panel 260 may include an editing option for the associated content for generating the media content, such as at least one of a type option (image or video) required to generate the media content, a text option for generating the media content, a template option, a special effect option, a music option, and the like.

In some embodiments, a music control 270 is also provided in the display panel 202 of the editing interface 200D. Illustratively, the music control 270 may present another permitted music content C determined based on the permitted music content A described by the detail panel 220a.

As an example, the permitted music content C may be determined based on at least one of the following similarities to the unpermitted music content A: a similarity to a work style of the unpermitted music content A, a similarity of work genres, a similarity of instruments used, a similarity of types of work rhythm (e.g., fast-paced, slow-paced, high-pitched, melodious type, etc.), whether the same author, and the like.

Based on the trigger for the music control 270, the music content on which the media editing is performed in the editing interface 200D may be replaced. For example, another permission music content that is switched based on a preset switching rule may be obtained by triggering the music control 270, or a search box or a corresponding music list of the permitted music content may be obtained by triggering the music control 270, so that the user searches or selects a target music content according to the requirement.

With continued reference to FIG. 2D, an editing panel 280 may also be provided in the editing interface 200D, and the editing panel 280 includes at least one editing control for generating media content.

In some embodiments, the editing control in the control panel 280 may include an operation control for a device (for example, a front camera or a rear camera, a flashlight, etc.) configured by the electronic device 110 for presenting the editing interface 200D, and may further include other editing control for generating media content, such as an interface proportional adjustment control, a special effect display control, or the like, which is not limited herein.

In the editing interface 200D shown in FIG. 2D, the user may operate at least one option control in the option panel 260, the music control 270, or at least one editing control in the editing panel 280 to generate a brand new media content. Illustratively, both the media content editing process generated during the user operation process and the new media content finally generated may be presented through the display panel 202.

In some illustrative implementation scenarios, the generated new media content may be presented as one of recommended media content, presented in the detail interface of the media content associated music content, e.g., as one of a set of media content 230b or 230c in the detail interface 200B or 200C.

As shown in FIGS. 2B and 2D, if the unpermitted music content A is described in the detail panel 220a of the detail interface 200B, at least one prompt information 290 may also be provided in the editing interface 200D presented after the editing portal 240a is triggered based on the unpermitted music content A.

Illustratively, the prompt information 290 may indicate that the permitted music content C presented in the current editing interface 200D is associated music content of the permitted music content A described by the detail panel 220a. For example, the currently presented music content is similar music content of the foregoing unpermitted music content A.

In this way, the provided permitted music content may be presented in association with the previous unpermitted music content, thereby avoiding the user from becoming confused for the presentation of the current editing interface and improving the user experience.

In some embodiments, the prompt information 290 is not always in a display state. As an example, the prompt information 290 may be automatically hidden after a preset duration (for example, 3 seconds or 5 seconds) upon entering the editing interface 200D. Alternatively, a close button may also be provided at a relevant position (for example, any position such as the upper right corner or the lower right corner or the upper left corner) of the prompt information 290, to hide the prompt information 290 based on a trigger for the close button. Alternatively, presentation of the prompt information 290 may be closed based on a trigger for any location in the current editing interface 200D, which is not limited herein.

### Example Process

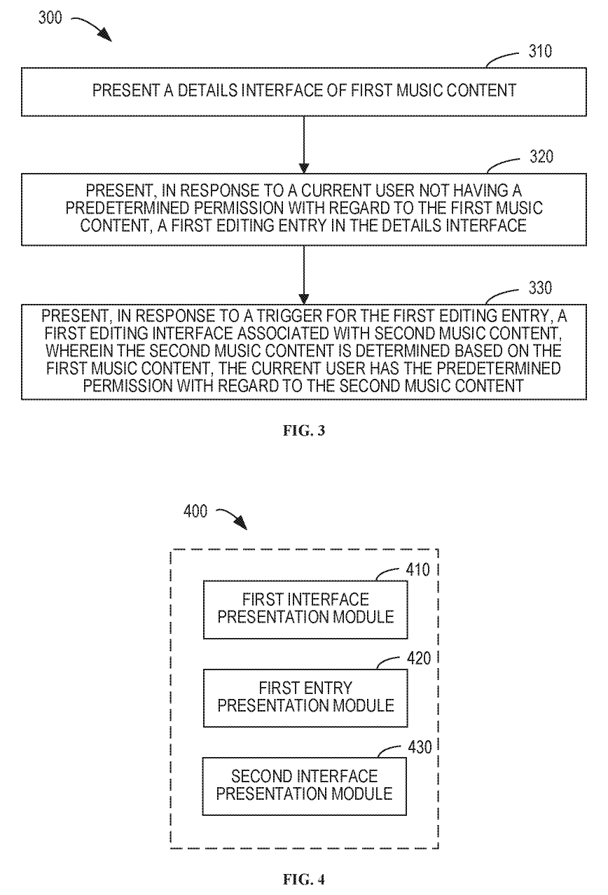

FIG. 3 shows a flowchart of an example process 300 of a method of interface interaction according to some embodiments of the disclosure. The process 300 may be implemented at the electronic device 110. The process 300 is described below with reference to FIG. 1.

As shown in FIG. 3, at block 310, the electronic device 110 presents a detail interface of first music content.

As an example, the detail interface presented by the electronic device 110 may refer to the detail interface 200B shown in FIG. 2B, and the first music content is the unpermitted music content A described by the detail panel 220a in the detail interface 200B.

With continued reference to FIG. 3, at block 320, the electronic device 110 presents, in response to a current user not having a predetermined permission with regard to the first music content, a first editing entry in the detail interface.

As an example, the first editing entry may refer to the editing entry 240a in the detail interface 200B shown in FIG. 2B.

In some embodiments, the current user not having the predetermined permission with regard to the first music content may include at least one of the following: the current user cannot completely hear all content of the first music content, the current user cannot use the first music content, the current user cannot edit or create the first music content, and the like.

With continued reference to FIG. 3, at block 330, the electronic device 110 presents, in response to a trigger for the first editing entry, a first editing interface associated with the second music content. The second music content is determined based on the first music content, and the current user has the predetermined permission with regard to the second music content.

As an example, the first editing interface may refer to the editing interface 200D shown in FIG. 2D.

According to the solution, the detail interface of the music content having no predetermined permission may be provided for the current user, the media editing entry based on the permitted music content determined by the music content is provided in the detail interface, the detail interface of the non-permission music content can be effectively enriched, the work conversion rate can be improved to a certain extent, and the user experience can be improved.

In some embodiments of the disclosure, the process 300 further includes: the electronic device 110 presenting first prompt information in the first editing interface, wherein the first prompt information indicates that the second music content is associated with the first music content.

As an example, the first prompt information may refer to the prompt information 290 in the editing interface 200D shown in FIG. 2D.

In this way, it may be clearly presented through the first prompt information that the second music content has an association with the first music content, thereby improving the user experience.

In some embodiments of the disclosure, the process 300 further includes: the electronic device 110 ceasing the presentation of the first prompt information in response to a presentation duration of the first prompt information reaching a preset duration or in response to receiving a first preset operation on the first editing interface.

As an example, the first prompt information may be automatically hidden after the first prompt information is presented for a preset duration such as 3 seconds or 5 seconds.

In some embodiments, the first preset operation may also be configured, and the first prompt information is hidden based on the first preset operation. Illustratively, the first preset operation may be any preset operation such as triggering, clicking, sliding, and the like of the first prompt information, or may be a preset operation such as clicking and sliding at a blank region or a control region in the first editing interface, which is not limited herein.

In this way, not only the first prompt information may be presented, but also the first prompt information may be hidden when conditions are met, so as to avoid the first prompt information excessively obstructing the first editing interface, and ensure the presentation effect of the editing process and the editing result in the first editing interface.

In some embodiments of the disclosure, a similarity between the first music content and the second music content is greater than a threshold.

As an example, the similarity between the first music content and the second music content may include at least one of the following: a similarity of related instruments, a similarity of content styles, a similarity of content rhythms, and the like.

In some embodiments of the disclosure, the second music content is determined through: determining, based on a similarity between the first music content and a set of candidate music contents, whether the set of candidate music contents includes candidate music content of which a similarity with the first music content is greater than a threshold; and determining, in response to the set of candidate music contents including at least one candidate music content of which the similarity with the first music content is greater than the threshold, the second music content from the at least one piece of candidate music content.

In this way, the second music content may be quickly determined from the set of candidate music contents, improving the presentation efficiency of the second music content.

In some embodiments of the disclosure, the process 300 further includes: the electronic device 110 associating the first editing entry with the third music content in response to the set of candidate music contents not including candidate music content of which the similarity with the first music content is greater than the threshold. The third music content is determined from the set of candidate music contents based on reference information of the current user.

In this way, in a case that the second music content is not found based on the similarity with the first music content, the third music content may be determined from the set of candidate music contents based on the reference information of the current user, and the first editing entry in the detail interface is associated with the third music content, so that the association between the music content associated with the provided first editing entry and the current user can be ensured, and the user experience can be improved.

In some embodiments of the disclosure, the process 300 further includes: the electronic device 110 updating the detail interface in response to the current user obtaining the predetermined permission, the updated detail interface presenting a second editing entry; and presenting, in response to a trigger for the second editing entry, a second editing interface associated with the first music content.

In this way, this solution enables updating the detail interface of the first music content in time after the user obtains a related permission of the first music content, and provides the second editing entry associated with the first music content, so that the work conversion efficiency of the first music content can be effectively improved, and the user experience can be improved.

In some embodiments of the disclosure, the process 300 further includes: the electronic device 110 generating, in response to a permission obtaining control provided in the detail interface being triggered, a permission obtaining request to obtain the predetermined permission with regard to the first music content.

In this way, the predetermined permission with regard to the first music content may be quickly obtained based on a permission obtaining control in the detail interface, and the obtaining efficiency of the predetermined permission is improved.

In some embodiments of the disclosure, the detail interface includes a first detail interface, and the process 300 further includes: the electronic device 110 presenting a second detail interface for fourth music content, wherein the current user has the predetermined permission with regard to the fourth music content, and a first interface style of the first detail interface is different from a second interface style of the second detail interface.

As an example, the first detail interface may refer to the detail interface 200B shown in FIG. 2B, the fourth music content may refer to the permitted music content B shown in FIG. 2C, and the second detail interface may refer to the detail interface 200C shown in FIG. 2C.

In this way, the detail interfaces of the permitted music content and the unpermitted music content may be distinguished in terms of interface style, improving the user experience.

In some embodiments of the disclosure, the first interface style indicates displaying a preset image as a cover image of the first music content; or the first interface style and the second interface style indicate presenting music description information in different display styles; or the second interface style indicates providing more music interaction control in the second detail interface than in the first detail interface.

In some embodiments of the disclosure, the process 300 further includes: the electronic device 110 presenting second prompt information in the detail interface, wherein the second prompt information indicates that the current user does not have the predetermined permission with regard to the first music content.

In some implementations, a display position of the second prompt information in the detail interface may be any position in the detail interface, for example, presented in the description information of the first music content, presented in a pop-up window or a dialog box in the detail interface, or the like.

As an example, the second prompt information is presented in the playback information 225 in the detail interface 200B shown in FIG. 2B.

In some embodiments of the disclosure, presenting the detail interface of the first music content includes: presenting a playback interface of the media content, the media content being associated with the first music content; and presenting, in response to receiving a second preset operation in the playback interface, the detail interface of the first music content.

In this way, this solution enables the detail interface of the first music content to be triggered in the playback interface of the media content associated with the first music content, providing the presentation path of the detail interface, ensuing the presentation efficiency, and improving the user experience.

### Example Apparatus and Device

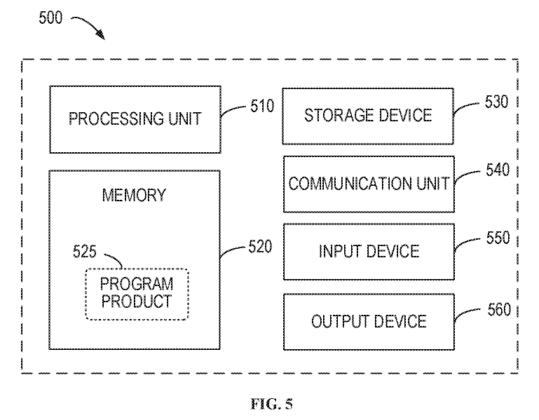

Embodiments of the disclosure also provide a corresponding apparatus for implementing the above method or process. FIG. 4 shows a schematic structural block diagram of an example apparatus 400 for interface interaction according to some embodiments of the disclosure. The apparatus 400 may be implemented or included in the electronic device 110. The various modules / components in the apparatus 400 may be implemented by hardware, software, firmware, or any combination thereof.

As shown in FIG. 4, the apparatus 400 includes: a first interface presentation module 410, a first entry presentation module 420, and a second interface presentation module 430. The first interface presentation module 410 is configured to present a detail interface of first music content. The first entry presentation module 420 is configured to present, in response to a current user not having a predetermined permission with regard to the first music content, a first editing entry in the detail interface. The second interface presentation module 430 is configured to present, in response to a trigger for the first editing entry, a first editing interface associated with second music content. The second music content is determined based on the first music content, and the current user has the predetermined permission with regard to the second music content.

In some embodiments, the apparatus 400 further includes a first information presentation module configured to present first prompt information in the first editing interface. The first prompt information indicates that the second music content is associated with the first music content.

In some embodiments, the apparatus 400 further includes an information hiding module configured to cease presenting the first prompt information in response to a presentation duration of the first prompt information reaching a preset duration or in response to receiving a first preset operation on the first editing interface.

In some embodiments, a similarity between the first music content and the second music content is greater than a threshold.

In some embodiments, the second music content is determined through: determining, based on a similarity between the first music content and a set of candidate music contents, whether the set of candidate music contents includes candidate music content of which a similarity with the first music content is greater than a threshold; and determining, in response to the set of candidate music contents including at least one candidate music content of which the similarity with the first music content is greater than the threshold, the second music content from the at least one candidate music content.

In some embodiments, the apparatus 400 further includes an entry association module configured to associate the first editing entry with third music content in response to the set of candidate music contents not including candidate music content of which the similarity with the first music content is greater than the threshold. The third music content is determined from the set of candidate music contents based on reference information of the current user.

In some embodiments, the apparatus 400 further includes an interface updating module and a third interface presentation module, wherein the interface updating module is configured to update the detail interface of the first music content in response to the current user obtaining the predetermined permission, the updated detail interface presenting a second editing entry; and the third interface presentation module is configured to present, in response to a trigger for the second editing entry, a second editing interface associated with the first music content.

In some embodiments, the apparatus 400 further includes a permission obtaining module configured to generate, in response to a permission obtaining control provided in the detail interface being triggered, a permission obtaining request to obtain the predetermined permission with regard to the first music content.

In some embodiments, the detail interface of the first music content is a first detail interface, and the apparatus 400 further includes a fourth interface presentation module configured to present a second detail interface for fourth music content, wherein the current user has the predetermined permission with regard to the fourth music content, and a first interface style of the first detail interface is different from a second interface style of the second detail interface.

In some embodiments, the first interface style indicates displaying a preset image as a cover image of the first music content; or the first interface style and the second interface style indicate presenting the music description information in different display styles; or the second interface style indicates providing more music interaction control in the second detail interface than in the first detail interface style.

In some embodiments, the apparatus 400 further includes a second information presentation module configured to present second prompt information in the detail interface, the second prompt information indicating that the current user does not have the predetermined permission with regard to the first music content.

In some embodiments, presenting the detail interface of the first music content includes: presenting a playback interface of media content, the media content being associated with the first music content; and presenting, in response to receiving a second preset operation in the playback interface, the detail interface of the first music content.

In the apparatus 400 provided in the embodiments of the disclosure, the specific processing process of various modules and the technical effects brought thereby may refer to the related description of the foregoing example process 300, and details are not described herein again.

As shown in FIG. 5, the electronic device 500 is in a form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In a multiprocessor system, multiple processing units execute computer-executable instructions in parallel to improve the parallel processing capability of the electronic device 500.

The electronic device 500 generally includes a plurality of computer storage media. Such media may be any available media accessible to the electronic device 500, including, but not limited to, volatile and non-volatile media, removable and non-removable media. The memory 520 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. The storage device 530 may be a removable or non-removable medium and may include a machine-readable medium, such as a flash drive, a magnetic disk, or any other medium, which may be capable of storing information and / or data and may be accessed within the electronic device 500.

The electronic device 500 may further include additional removable / non-removable, volatile / non-volatile storage media/medium. Although not shown in FIG. 5, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the disclosure.

The communication unit 540 is configured to communicate with other electronic device through a communication medium. Additionally, the functionality of components of the electronic device 500 may be implemented in a single computing cluster or multiple computing machines capable of communicating through a communication connection. Thus, the electronic device 500 may operate in a networked environment using logical connections with one or more other servers, network personal computers (PCs), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, the external device such as a storage device, a display device, etc., communicates with one or more devices that enable a user to interact with the electronic device 500, or communicate with any device (e.g., a network card, a modem, etc.) that enables the electronic device 500 to communicate with one or more other electronic devices. Such communication may be performed via an input / output (I / O) interface (not shown).

According to example implementations of the disclosure, there is provided a computer-readable storage medium having computer-executable instructions stored thereon, wherein the computer-executable instructions are executed by a processor to implement the method described above. According to example implementations of the disclosure, a computer program product is further provided, the computer program product being tangibly stored on a non-transitory computer-readable medium and including computer-executable instructions, and the computer-executable instructions being executed by the processor to implement the method described above.

Aspects of the disclosure are described herein with reference to flowcharts and / or block diagrams of a method, an apparatus, a device, and a computer program product implemented in accordance with the disclosure. It should be understood that each block of the flowchart and / or block diagram, and combinations of blocks in the flowchart(s) and / or block diagram(s), may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions / acts specified in one or more blocks in the flowchart(s) and / or block diagram(s). These computer-readable program instructions may also be stored in a computer-readable storage medium that cause the computer, programmable data processing apparatus, and / or other devices to function in a particular manner, such that the computer-readable medium storing instructions includes an article of manufacture including instructions to implement aspects of the functions / acts specified in one or more blocks in the flowchart(s) and / or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on the computer, other programmable data processing apparatus, or other apparatus implement the functions / acts specified in one or more blocks in the flowchart(s) and / or block diagram(s).

The flowchart and block diagrams in the figures show an architecture, functionality, and operation that may be possibly implemented by a system, a method, and a computer program product according to various implementations of the disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagram(s) and / or flowchart(s), as well as combinations of blocks in the block diagram(s) and / or flowchart(s), may be implemented with a dedicated hardware-based system that performs the specified functions or actions, or may be implemented in a combination of dedicated hardware and computer instructions.

Various implementations of the disclosure have been described above, which are illustrative, not exhaustive, and are not limited to the implementations disclosed. Many modifications and variations will be apparent to those of ordinary skill in the art without departing from the scope and spirit of various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method of interface interaction, comprising:
presenting a detail interface of first music content;
presenting, in response to a current user lacking a predetermined permission with regard to the first music content, a first editing entry in the detail interface; and
presenting, in response to a trigger for the first editing entry, a first editing interface associated with second music content, wherein the second music content is determined based on the first music content, the current user has the predetermined permission with regard to the second music content.

2. The method of claim 1, further comprising:
presenting first prompt information in the first editing interface, wherein the first prompt information indicates that the second music content is associated with the first music content.

3. The method of claim 2, further comprising:
ceasing the presentation of the first prompt information in response to a presentation duration of the first prompt information reaching a preset duration or in response to receiving a first preset operation on the first editing interface.

4. The method of claim 1, wherein a similarity between the first music content and the second music content is greater than a threshold.

5. The method of claim 1, wherein the second music content is determined through:
determining, based on a similarity between the first music content and a set of candidate music contents, whether the set of candidate music contents comprises candidate music content of which a similarity with the first music content is greater than a threshold; and
determining, in response to the set of candidate music contents comprising at least one candidate music content of which the similarity with the first music content is greater than the threshold, the second music content from the at least one candidate music content.

6. The method of claim 5, further comprising:
associating the first editing entry with third music content in response to the set of candidate music contents lacking candidate music content of which the similarity with the first music content is greater than the threshold, wherein the third music content is determined from the set of candidate music contents based on reference information of the current user.

7. The method of claim 1, further comprising:
updating the detail interface in response to the current user obtaining the predetermined permission, wherein the updated detail interface presents a second editing entry; and
presenting, in response to a trigger for the second editing entry, a second editing interface associated with the first music content.

8. The method of claim 7, further comprising:
generating, in response to a permission obtaining control provided in the detail interface being triggered, a permission obtaining request to obtain the predetermined permission with regard to the first music content.

9. The method of claim 1, wherein the detail interface is a first detail interface, and the method further comprises:
presenting a second detail interface for fourth music content, wherein the current user has the predetermined permission with regard to the fourth music content, and a first interface style of the first detail interface is different from a second interface style of the second detail interface.

10. The method of claim 9, wherein:
the first interface style indicates displaying a preset image as a cover image of the first music content; or
the first interface style and the second interface style indicate presenting music description information in different display styles; or
the second interface style indicates providing more music interaction controls in the second detail interface than in the first detail interface.

11. The method of claim 1, further comprising:
presenting second prompt information in the detail interface, the second prompt information indicating that the current user lacks the predetermined permission with regard to the first music content.

12. The method of claim 1, wherein presenting the detail interface of the first music content comprises:
presenting a playback interface of media content, the media content being associated with the first music content; and
presenting, in response to receiving a second preset operation in the playback interface, the detail interface of the first music content.

13. An electronic device, comprising:
at least one processor; and
at least one memory coupled to the at least one processor and storing instructions for execution by the at least one processor, the instructions, when executed by the at least one processor, causing the electronic device to perform acts comprising:
presenting a detail interface of first music content;
presenting, in response to a current user lacking a predetermined permission with regard to the first music content, a first editing entry in the detail interface; and
presenting, in response to a trigger for the first editing entry, a first editing interface associated with second music content, wherein the second music content is determined based on the first music content, and the current user has the predetermined permission with regard to the second music content.

14. The electronic device of claim 13, wherein the acts further comprise:
presenting first prompt information in the first editing interface, wherein the first prompt information indicates that the second music content is associated with the first music content.

15. The electronic device of claim 13, wherein a similarity between the first music content and the second music content is greater than a threshold.

16. The electronic device of claim 13, wherein the second music content is determined through:
determining, based on a similarity between the first music content and a set of candidate music contents, whether the set of candidate music contents comprises candidate music content of which a similarity with the first music content is greater than a threshold; and
determining, in response to the set of candidate music contents comprising at least one candidate music content of which the similarity with the first music content is greater than the threshold, the second music content from the at least one candidate music content.

17. The electronic device of claim 13, wherein the acts further comprise:
updating the detail interface in response to the current user obtaining the predetermined permission, wherein the updated detail interface presents a second editing entry; and
presenting, in response to a trigger for the second editing entry, a second editing interface associated with the first music content.

18. The electronic device of claim 13, wherein the detail interface is a first detail interface, and the method further comprises:
presenting a second detail interface for fourth music content, wherein the current user has the predetermined permission with regard to the fourth music content, and a first interface style of the first detail interface is different from a second interface style of the second detail interface.

19. The electronic device of claim 13, wherein the acts further comprise:
presenting second prompt information in the detail interface, the second prompt information indicating that the current user lacks the predetermined permission with regard to the first music content.

20. A non-transitory computer-readable storage medium having stored thereon a computer program executable by a processor to perform acts comprising:
presenting a detail interface of first music content;
presenting, in response to a current user lacking a predetermined permission with regard to the first music content, a first editing entry in the detail interface; and
presenting, in response to a trigger for the first editing entry, a first editing interface associated with second music content, wherein the second music content is determined based on the first music content, the current user has the predetermined permission with regard to the second music content.
